(19) United States
(12) Patent Application Publication
(10) Pub. No.: US 2014/0106853 A1
(43) Pub. Date: Apr. 17, 2014

(54) CARD GAMES

(71) Applicant: Chi Fat AU-YEUNG, Edgbaston (GB)

(72) Inventor: Chi Fat AU-YEUNG, Edgbaston (GB)

(21) Appl. No.: 14/106,952

(22) Filed: Dec. 16, 2013

Related U.S. Application Data
(63) Continuation-in-part of application No. 13/879,087, filed on Apr. 12, 2013.

(30) Foreign Application Priority Data
Nov. 4, 2010 (GB) 1018589.0

(51) Int. Cl. A63F 13/00; A63F 1/00

(52) U.S. Cl. CPC A63F 13/005; A63F 1/00
USPC 463/22; 273/292

(57) ABSTRACT

A card game having a playing area divided into a plurality of player areas, each player area having a bet area in which players may place an Ante-bet to participate in the game; a dealer dealing two or more cards to the or each player's player area; the or each player having the option to stand on the original two or more cards dealt to the player's player area or to place an additional Exchange-bet in an Exchange-bet area of the player's player area, to exchange at least one of the two or more cards originally dealt to the player area for an equal number of new cards; the outcome of the game being decided on the rank of the or each player's hand comprising the originally dealt cards and any exchange cards, plus any additional individual or common cards, winning Ante and Exchange-bets being paid out in accordance with odds specified in a pay-table.

### FIELD OF INVENTION

The present invention relates to card games and in particular card games such as Blackjack, Baccarat or Poker, in which two or more cards are dealt to a player's hand and two or more cards are dealt to a dealer's hand, the player's hand being compared to the dealer's hand decide the outcome of the game. Depending on the actual game the player's hand and the dealer's hand may comprise only the initial two or more cards dealt to the hand or may comprise additional individual cards or common cards.

### SUMMARY OF INVENTION

According to one aspect of the present invention, a card game comprises the steps of;
a. providing a playing area divided into a plurality of player areas;
b. at least one player placing a Ante-bet in a bet area of one of said player areas to participate in the game;
c. a dealer dealing two or more cards to the or each player's player area;
d. the or each player having the option to stand on the original two or more cards dealt to the player's player area or place an additional Exchange-bet in an Exchange-bet area of the player's player area, to exchange at least one of the two or more cards originally dealt to the player area for an equal number of new cards;
e. the rank of the or each player's completed hand comprising the originally dealt cards not exchanged and any exchange cards, plus any additional individual or common cards being compared to a pay-table, to determine the outcome of the Ante-bet and any Exchange-bet, the Ante-bet and Exchange-bet being paid out at odds specified in the pay-table.

According to a further aspect of the present invention, a card game comprises the steps of;
a. providing a playing area divided into a plurality of player areas;
b. at least one player placing a Ante-bet in a bet area of one of said player areas to participate in the game;
c. a dealer dealing two or more cards to the or each player's player area and two or more cards to the dealer;
d. the or each player having the option to stand on the original two or more cards dealt to the player's player area or place an additional Exchange-bet in an Exchange-bet area of the player's player area, to exchange at least one of the two or more cards originally dealt to the player area for an equal number of new cards;
e. the dealer standing on the original two or more cards dealt to the dealer if the value of said cards is equal to or above a pre-determined minimum value or exchanging one or more cards for an equal number of new cards if the value of the initial cards dealt to the dealer is below the per-determined minimum value;
f. the rank of the or each player's completed hand comprising the originally dealt cards not exchanged and any exchange cards, plus any additional individual or common cards being compared to the dealer's completed hand comprising the originally dealt cards not exchanged and any exchange cards, plus any additional individual or common cards, to determine the outcome of the Ante-bet and any Exchange-bet, the player's Ante-bet and Exchange-bet being paid out at odds specified in the pay-table.

The incorporation of an exchange element introduces additional skill factors in what have hitherto tended to be games of pure chance or games with a very small element of skill.

According to one embodiment the player, upon placing an Exchange-bet, may exchange any number of cards up to one less that the original number of cards.

The Exchange-bet is preferably equal to the Ante-bet placed by the player.

The player preferably discards the card or cards he wishes to exchange before the cards are exchanged, the player for example discarding the card or cards at the same time as placing his Exchange-bet.

### BRIEF DESCRIPTION OF THE DRAWINGS

The invention is now described, by way of example only, with reference to the accompanying drawing in which;

FIG. 1 illustrates a playing area for a card game in accordance with the present invention; and

FIG. 2 illustrates an alternative playing area for a card game in accordance with the present invention

### DETAILED DESCRIPTION OF THE PREFERRED EMBODIMENTS

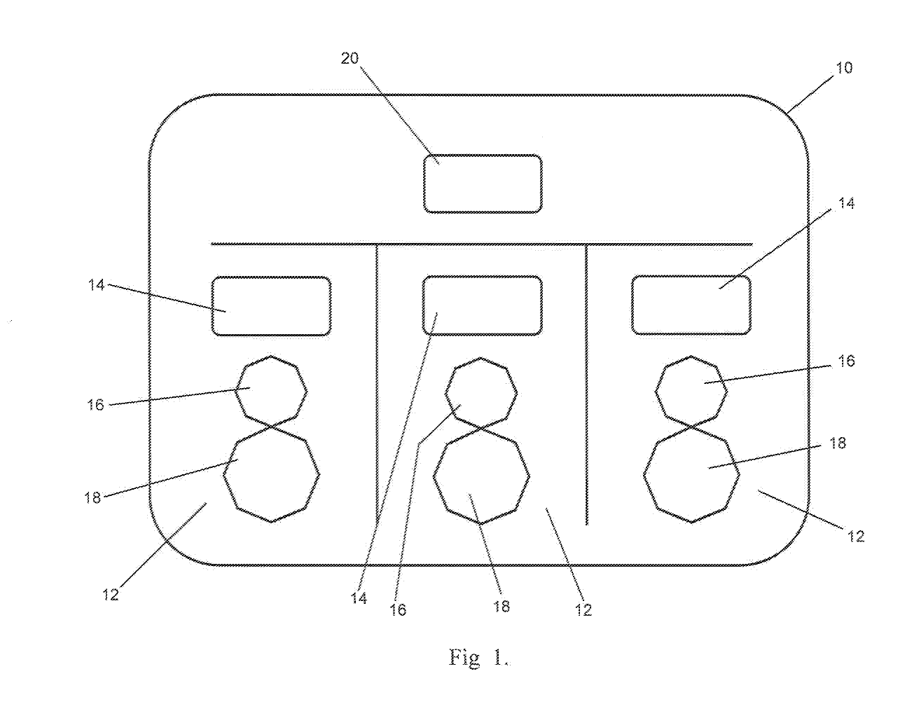

As illustrated in FIG. 1 the playing area 10 is divided into a plurality of player areas 12, each player area 12 having an area 14 in which an individual player hand may be dealt, a bet area 16 and an Exchange-bet area 18. The playing area 10 also includes an area 20 in which a dealer's hand may be dealt.

According to one embodiment based on Three Card Draw Poker, each player wishing to participate in the game places a bet in area 16 of a player area 12, each player selecting a different player area 12.

Front a single deck of cards, the dealer then deals three cards face down to areas 14 of the playing areas 12 of each participating player and three cards face down to himself in area 20.

Each player then has the option of standing with the original three cards dealt to the player's player area 12 or to exchange one card. If the player wishes to exchange he must first place an Exchange-bet equal to his Ante-bet in Exchange-bet area 18 of his player area 12 and discard the card or cards he wishes to exchange. The dealer collects all discards and deals in turn the replacement cards, in turn to each of the players placing an Exchange-bet.

If the original three cards dealt to the dealer produce a (three-card) Flush, Straight, Straight-Flush or Three of a Kind, the dealer must retain all three cards. Otherwise the Dealer must discard one card retaining a two-card drawing hand using the following criteria in priority order:

Two Cards to be Retained:
1. Keep Pair;
2. Keep two cards to a Straight-Flush draw, holding 2-3, 2-4, . . . , Q-K, K-A (Suited connectors));
3. Keep two to a Open-Ended Straight draw (holding 2-3, 3-4, . . . 9-10, J-Q, Q-K);
4. Keep two to a Flush draw (holding two same-suit cards);
5. Keep two to the highest possible Inside Straight (holding; A-2, 2-4, . . . , J-K, K-A).
6. Keep the two highest cards.

The completed hand of each Player, comprising all three original cards or two original cards and one exchanged card, is then compared with the Dealer's completed hand comprising all three original cards or two original cards and one exchanged card. If the Player's completed hand is of higher rank than that of the Dealer in ascending order:
i. High Card
ii. Pair
iii. Flush
iv. Straight
v. Three of a Kind
vi. Straight Flush
vii. Royal Flush

the player will win and the player's Ante-bet is paid out at specified odds, for example the player's Ante-bet is paid out at odds of 1 to 1 and any Exchange-bet is paid out at odds in accordance with the following pay-table:

| Player's completed hand | |
|---|---|
| of two original cards and | |
| one exchange card | Odds |
| Royal Flush | 25 to 1 |
| Straight Flush | 5 to 1 |
| Three of a Kind | 4 to 1 |
| Straight, | 2 to 1 |
| Flush or Pair | 1 to 1 |
| Other | Push |

In an alternative embodiment based on Three-Card Low Ball Draw Poker the game is played in the same manner as Three Card Draw Poker as described above, the winning hand is however the hand of lower value, the lowest possible hand being 4-2-A unsuited.

In this alternative embodiment, the dealer must stand with Queen high or lower. Otherwise dealer must exchange a single card using the following criteria in priority order:
1. With three of a kind discard any card.
2. With Flush, Straight or Straight-Flush discard highest card.
3. With Pair discard one of the pair
4. With King high discard King

The completed hand of each player is then compared with the dealer's completed hand. If the player's completed hand is of higher rank than the dealer's completed hand, in the ascending order:
a. Straight Flush;
b. Three of a kind;
c. Straight;
d. Flush;
e. Pair;
f. High Card;
   the player will win and the player's Ante-bet is paid out at specified odds.

According to a further embodiment of the present invention based Five Card Stud Draw Poker, each player wishing to participate in the game places a bet in area 16 of a player area 12, each player selecting a different player area 12.

Five cards are dealt face down to the playing area 12 of each participating player and five cards are dealt face down to the dealer in area 20, from a deck comprising a single deck of cards.

The player has the option of standing on the original cards or placing an Exchange-bet equal to his Ante-bet and exchanging one card, the player discarding the card he wishes to exchange before being dealt replacement card or stay with his original five cards.

The dealer must keep all five cards with a Straight or higher. Otherwise the dealer must discard one, two or three cards using the following criteria in priority order:
1. Keep four to a Straight-Flush draw, exchanging one card.
2. Keep four to a Flush draw, exchanging one card.
3. Keep four to an Open-ended Straight draw, exchanging one card.
4. Keep three of a kind; exchanging two cards.
5. Keep a Pair, exchanging three cards.
6. Keep four to a (higher) Middle-pin Straight draw, exchanging one card.
7. Keep two highest cards, exchanging three cards.

The completed five card hand of each player is then compared with the dealer's completed five card. If the player's completed hand is of higher rank than the dealer's completed hand, in the descending order:

| | |
|---|---|
| Royal Flush | Ace-King-Queen-Jack-Ten Same Suit; |
| Straight Flush | Five same suited cards in sequence; |
| Four of a kind | Four same ranked cards; |
| Full House | Three same ranked cards and a pair; |
| Flush | Five same suited cards (not in sequence); |
| Straight | Five cards in sequence (mixed suits); |
| Three of a kind | Three same ranked cards; |
| Two Pairs; | |
| One Pair; | |
| High card; | |

the player will win and the player's Ante-bet and any Exchange-bet will be paid out at specified odds.

According to another embodiment of the present invention based on Texas Hold'em Poker each player wishing to participate in the game places a bet in area 16 of a player area 12, each player selecting a different player area 12.

From a single deck of cards, the dealer then deals two personal cards face down to the player area 12 of each participating player and two cards face down to the dealer in box 20.

Each player then has the option of standing on the original two personal cards dealt to him or placing an Exchange-bet in area 18 of his player area 12 and exchanging one of the two original personal cards, the player discarding the card be wishes to exchange before being dealt a replacement card.

After all participating players have stood or exchanged a card, the two cards dealt to the dealer are exposed. The dealer must keep both original cards when both are higher than 9 or same ranked. Otherwise the dealer must exchange one card, discarding the lower ranked card retaining the higher ranked card.

The dealer then deals five community cards face up.

The best five card poker hand of each player, made up from the five community cards and two remaining personal cards is then compared with the dealer's best poker hand made up from the five community cards and the remaining two dealer's cards. If the player's best poker hand is of higher rank than the dealer's best poker hand, in the descending order

| | |
|---|---|
| Royal Flush | Ace-King-Queen-Jack-Ten Same Suit; |
| Straight Flush | Five same suited cards in sequence; |
| Four of a kind | Four same ranked cards; |
| Full House | Three same ranked cards and a pair; |
| Flush | Five same suited cards (not in sequence); |
| Straight | Five cards in sequence (mixed suits); |
| Three of a kind | Three same ranked cards; |
| Two Pairs; | |
| One Pair; | |
| High card; | |

the player will win and the player's Ante-bet and any Exchange-bet will be paid out at specified odds, for example the player's Ante-bet is paid at odds of 1 to 1 and any Exchange-bet made by the player is paid in accordance with the following pay-table:

| Player's Hand | Odds |
|---|---|
| Royal Flush | 50 to 1 |
| Straight Flush | 20 to 1 |
| 4 of a Kind | 8 to 1 |
| Pair to Full House | 1 to 1 |
| Ace High or less | Push. |

According to an embodiment of the game based on Baccarat the dealer deals three cards to each player and the dealer, from eight decks of cards which have been shuffled together, Standard Baccarat point-count rules apply, card values being aggregated and the last digit only being used to provide the point count of the hand.

Each player has the option of standing on the original three cards or paying an Exchange-bet equal to an Ante-bet made by the player to participate in the game, in order to exchange one card, the player discarding the card he wishes to exchange before being dealt a replacement card.

After all the players have stood or replaced a card, the dealer must stand with six to nine points. With five or fewer points dealer must exchange one card keeping the two cards making the highest point, for example if the dealer's original cards are 7-8-9, the hand value is 4 (24 last digit-4), the dealer must exchange one card, keeping the 8 and 9; with 10-8-4 hand value is 2 and the dealer must keep the 10 and 8 drawing a further card to replace the 4.

If on comparison of each player's completed hand comprising all three original cards or two original cards and one exchange card with the dealer's completed hand comprising all three original cards or two original cards and one exchange card, the player's hand has a greater value than the dealer's hand, the player wins and the player's Ante-bet and Exchange-bet if any, are paid at specified odds.

According to an embodiment of the game based on Blackjack each player wishing to participate in the game places a bet in area 16 of a player area 12, each player selecting a different player area 12.

The dealer then deals two cards face up to each player and two cards one face up the other face down to the dealer, from six decks of cards which have been shuffled together.

Each player has the option of standing on the original two cards dealt to him or placing an Exchange-bet equal to his Ante-bet, to replace the second (Top) card dealt to his hand. After standing or exchanging his second card the player plays his hand according to the standard rules of Blackjack, standing on the remaining two cards, splitting if appropriate, doubling or drawing additional cards.

After all the players have completed play of their hand, the dealer exposes his second (Hole) card. If dealer's two cards make 14 to 17, the dealer must exchange his Hole card. With all other totals the dealer must play with the original two cards dealt to him. The dealer's hand is then played according to standard rules of Blackjack.

If the completed hand of each player is 21 or less and higher than the dealer's, or if the player's hand is 21 or less and the dealer's hand exceeds 21, then the player wins and his Ante-bet and Exchange-bet if any, are paid at specified odds.

According to a variation of the game based on blackjack described above, the player may only place an Exchange-bet and exchange the second card dealt to him if the total of the original two cards dealt to him is 12 or higher.

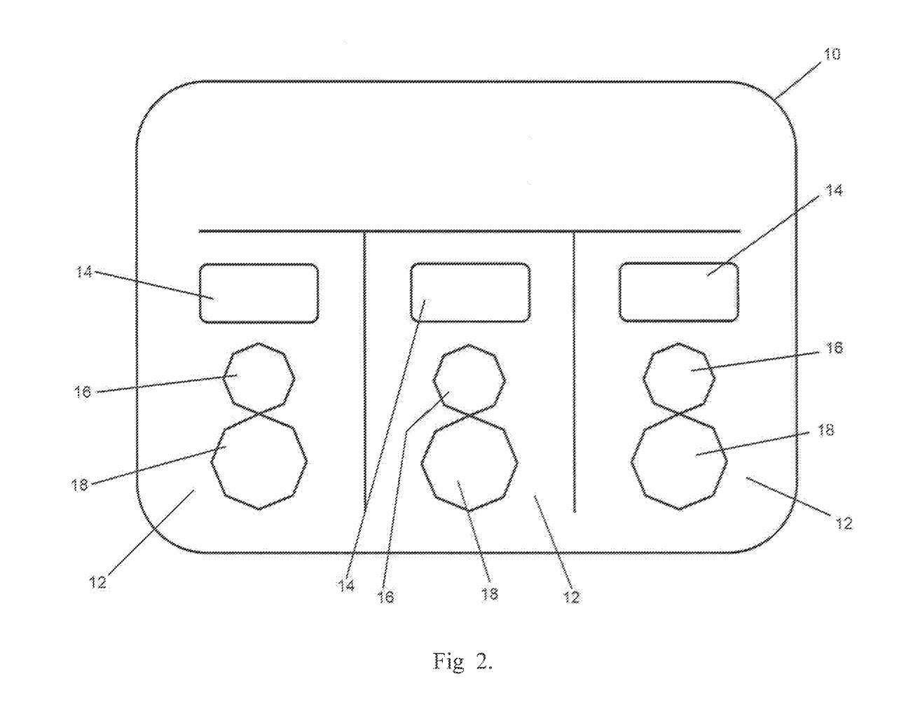

According to a further embodiment of the game, the area 20 may be omitted from the playing area 10, as illustrated in FIG. 2. The dealer deals two or more cards to the player area of each participating player who has placed an Anti-bet in area 16. Each participating player then having the option to stand on the original cards dealt to the player's area or placing an additional Exchange-bet in the Exchange-bet area 18 to exchange at least one of the two or more cards to the player area for an equal number of cards. The rank of each player's completed hand, comprising originally dealt cards which have not been exchanged, any exchange cards, plus any additional individual or common cards, then being compared against a pay-table, winning anti and Exchange-bets being paid out at odds in accordance with the pay-table.

A version of three card poker played in accordance with this further embodiment comprises:
a. each player wishing to participate in the game placing an Anti-bet in area 16 of one of the player areas 12;
b. the dealer dealing three cards to each of the participating players in area 14 of the player's player area;
c. each player either standing on the original three cards dealt to the player's player area, or placing an Exchange-bet in area 18 of the player's player area 12 and exchanging one of the originally cards dealt to the player's player area for one exchange card;

the rank of the player's hand of three cards comprising originally dealt cards which have not been exchanged and any exchange card then being compared against the following pay-table to determine the outcome of the player's Ante-bet and any Exchange-bet made by the player.

Pay-Table

Odds.

| Player's Hand | Ante-bet | Exchange-bet |
|---|---|---|
| Royal Flush (A-K-Q suited) | 15 to 1 | 15 to 1 |
| Straight Flush (e.g. 3-4-5 suited) | 5 to 1 | 5 to 1 |
| Tree-of-a-kind(e.g. 7-7-7) | 3 to 1 | 3 to 1 |
| Straight (e.g. 5-6-7) | 2 to 1 | 3 to 1 |
| Flush (e.g. 4-9-10 suited) | 2 to 1 | 1 to 1 |
| High Pair (Queens or better) | 1 to 1 | Push |
| Low pair (Jacks or lower) | 0.5 to 1 | Push |
| High card (e.g. 4-8-K) | Loss | Loss |

Various modifications may be made to the embodiments of the invention described above. For example the number of decks used to play the game may be varied and a card or cards may be added to or removed from the deck or decks in use. The game may be played with a joker added to the deck or decks with pre-designated values as a limited or unlimited wild card. Alternatively a version of the game may he played with a pre-nominated card (e.g. 2 of Clubs) or cards (e.g. one eyed-jacks) designated as limited or unlimited wild cards.

The number of cards the player may exchange may be varied. The value of the Exchange-bet may he different to the Ante-bet. The ranking pay-table and odds relating to the version of game in play may be varied. The player and/or dealer may have more that one opportunity of exchanging cards, the player each time placing an Exchange-bet.

A progressive or jackpot side-game may be included in which a player who exercises his exchange option, doubles or otherwise increase the value of his bet on the side-game.

A version of the game may be played with bonus payments made either with or without a side or subsidiary bet for achieving a pre-designated hand or better or for losing to the dealer with a pre-designated hand or better (bad-bet).

The game or any variation thereof may be played in electronic form, by remote betting, on the world wide web, on the Internet, on a local area or remote network, with virtual or part-virtual components, on video screens, using computer programs, interactive television, by way of scratch-card or lottery or as a family or fun game or any combination thereof.

The playing area may be defined by any material, whether real, virtual, artificially illuminated or otherwise.

1. A card game comprising the steps of;
a. providing a playing area divided into a plurality of player areas;
b. at least one player placing an Ante-bet in a bet area of one of said player areas to participate in the game;
c. a dealer dealing two or more cards to the or each player's player area;
d. the or each player having the option to stand on the original two or more cards dealt to the player's player area or to place an additional Exchange-bet in an Exchange-bet area of the player's player area, to exchange at least one of the two or more cards originally dealt to the player area for an equal number of new cards;
e. the rank of the or each player's completed hand comprising the originally dealt cards not exchanged and any exchange cards, plus any additional individual or common cards; being compared to a pay-table to determine the outcome of the Ante-bet and any Exchange-bet, the Ante-bet and any Exchange-bet being paid out at odds specified in the pay-table.

2. A card game according to claim 1 in which the player may exchange any one or more of the cards originally dealt to the player's player area.

3. A card game according to claim 1 in which the player may exchange only specified card or cards of the original cards dealt to the player's playing area.

4. A card game according to claim 1 in which the player must retain at least one of the original cards dealt to the player's player area.

5. A card game according to claim 1 in which the player discards the card or cards he wishes to exchange before replacement cards are dealt to the player.

6. A card game according to claim 1 in which each player has more than one option of exchanging one or more cards.

7. A card game according to claim 1 in which the Exchange-bet is of equal value to the player's Ante-bet.

8. A card game according to claim 1 based on Three Card Poker, Three Card Low-Ball Draw Poker, Five Card Stud, Texas Holdem Poker, Draw Baccarat and Blackjack and variations thereof.

9. A card game according to claim 1 in which the game may be played or reproduced in electronic format, by remote betting on the world wide web, on the internet, on a local area. network or remote network, or by way of scratch-card or lottery, or as a family game or a fun game.

10. A card game comprising the steps of;
a. providing a playing area divided into a plurality of player areas;
b. at least one player placing an Ante-bet in a bet area of one of said player areas to participate in the game;
c. a dealer dealing two or more cards to the or each player's player area and two or more cards to the dealer;
d. the or each player having the option to stand on the original two or more cards dealt to the player's player area or to place an additional Exchange-bet in an Exchange-bet area of the player's player area, to exchange at least one of the two or more cards originally dealt to the player area for an equal number of new cards;
e. the dealer standing on the original two or more cards dealt to the dealer, if the value of said cards is equal to or above a pre-determined minimum value, or exchanging one or more cards for an equal number of new cards, if the value of the initial cards dealt to the dealer is below the pre-determined minimum value;
f. the rank of the or each player's completed hand comprising the originally dealt cards not exchanged and any exchange cards, plus any additional individual or common cards; being compared with the rank of the dealer's hand comprising the originally dealt cards not exchanged and any exchange cards, plus any additional individual or common cards to determine the outcome of the Ante-bet and any Exchange-bet, the player's winning bets being paid out at odds specified in a pay-table.

11. A card game according to claim 10 in which the player may exchange any one or more of the cards originally dealt to the player's player area.

12. A card game according to claim 10 in which the player may exchange only specified card or cards of the original cards dealt to the player's playing area.

13. A card game according to claim 10 in which the player must retain at least one of the original cards dealt to the player's player area.

14. A card game according to claim 10 in which the player discards the card or cards he wishes to exchange before replacement cards are dealt to the player.

15. A card game according to claim 10 in which each player has more than one option of exchanging one or more cards.

16. A card game according to claim 10 in which the Exchange-bet is of equal value to the player's Ante-bet.

17. A card game according to claim 10 based on Three Card Poker, Three Card Low-Ball Draw Poker, Five Card Stud, Texas Holdem Poker, Draw Baccarat and Blackjack and variations thereof.

18. A card game according to claim 10 in which the game may be played or reproduced in electronic format, by remote betting on the world wide web, on the internet, on a local area network or remote network, or by way of scratch-card or lottery, or as a family game or a fun game.
